(19) United States
(12) Patent Application Publication
(10) Pub. No.: US 2006/0269028 A1
(43) Pub. Date: Nov. 30, 2006

(54) Procedure for the synchronization of nodes of a network and associated network

(76) Inventors: Bert Bley, Essen (DE); Manfred Gronauer, Essen (DE); Gunter Mugge, Munster (DE)

Correspondence Address: CHADBOURNE & PARKE, L.L.P., 30 Rockefeller Plaza, New York, NY, 10112, US

(21) Appl. No.: 11/388,819

(22) Filed: Mar. 24, 2006

(30) Foreign Application Priority Data
Mar. 24, 2005 (EP) 05006464.1

(51) Int. Cl. H04L 7/00

(52) U.S. Cl. 375/354

(57) ABSTRACT

The invention relates to a method for the synchronization of at least two network nodes (A, B) which connect with one another in a network designed for the wireless transmission of data, in particular a sensor network designed for the wireless transmission and processing of usage measurement data. The synchronization of network nodes initiate a communication connection between them through a synchronization message packet bounded within a time period (T_{SP}) which is transmitted by a first network node (A) at time intervals (T₁) with a plurality of synchronization messages and at least one second network node (B) opens a temporally bounded reception window at time intervals (T₂) within which the at least one synchronization message can be received.

### RELATED APPLICATIONS

The present invention claims all rights of priority to European Patent Application No. 05006464.1, filed on Mar. 24, 2005, which is hereby incorporated by reference.

### FIELD OF THE INVENTION

The invention relates to a method for the synchronization of at least two network nodes which connect with one another in a network designed for the wireless transmission of data, in particular a sensor network designed for the wireless transmission and processing of usage measurement data.

In addition to this, the invention relates to an associated network, in particular a sensor network for the wireless transmission of data, in particular usage measurement data, with at least two network nodes which can connect with one another and each comprise at least one transmitting unit and one receiving unit, a sensor unit, means for the temporal control of their transmitting and receiving operation, and a power supply, where the transmission unit of at least one first network node (A) transmits at least one synchronization message at time intervals (T_{S}) and the receiving unit of at least one second network node (B) opens a temporally bounded reception window at time intervals (T₂) within which the at least one synchronization message can be received, where after successful reception communication can take place.

For a wireless transmission of usage measurement data from various usage measurement instruments or usage meters such as, for example, heating meters, electronic heating cost distributors, gas, water, or electric meters as they are used in homes and apartment buildings, radio-based sensor networks represent with increasing attractiveness an ideal transmission system for data collection.

### SUMMARY OF THE INVENTION

The possibility presents itself of collecting usage data by means of a radio reading of the usage meter for a usage-dependent accounting without a service worker even, the entering the premises in which the usage meter or usage meters are installed. Wireless sensor networks (WSN) comprise in general several network nodes which can connect with one another. As a rule, the network nodes comprise a transmitting and receiving unit, a sensor unit with a sensor as measuring sensor, and a power supply. Moreover, the network nodes of a network or the sensor nodes of a sensor network can also comprise evaluation devices as well as actuators or control and/or regulator devices.

Sensor networks are scaleable and offer a high degree of reliability, fault tolerance, and, with low internal energy consumption, a long service lifetime of the network components. In particular in connection with the life expectancy of network components, the energy available within the network represents a limiting factor so that, along with power-saving components and energy optimized algorithms, means are also used for controlling and limiting the transmitting and receiving operation of individual network nodes.

For the reduction of energy consumption it is a known practice to activate the transmitting unit of a network node formed for the transmission of data and/or control commands at time intervals, e. g. several times a day, where a transmission window is opened in which the transfer of data and/or control commands can take place. A transfer takes place for the most part unidirectionally and also without synchronization so that network nodes act either as transmitter or as receiver, whereby the need for energy of a network node is significantly reduced due to its limited function. The radio receivers within a sensor network are predominantly formed as stationary data collection centers, which are switched without interruption to readiness for reception. Those skilled in the art refer to such a state of a reception station as “idle listening.”

In the case of a battery-operated data collection station, “idle listening” is however not justified due to the unnecessarily high consumption of energy. It is thus also a known practice to activate a receiver for certain time intervals, which however requires that the transmitter as well as the receiver each has its own timer for the generation of its own time base, on the basis of which synchronization between the transmitter and the receiver is possible.

Here it is necessary that at least one of the two network nodes which can connect with one another, i. e. the transmitter or the receiver, knows in which time intervals and/or at which time points a transmission between the other network node takes place. If, for example, it is known to the receiver at which time points the transmission unit of a network node transmits, then the receiver can go to reception at these time points on the basis of its own time base.

It has turned out to be problematic here that the time base of each of the network nodes has an increased temperature dependence, e. g. due to the realization of the time generator with oscillating quartz crystals. In the following, time generator means the internal clock of a network node. Thus it can, for example, be the case that with an elevated ambient temperature of a network node A, e. g. a transmitter, its time base runs significantly fast with respect to that of a network node B, e. g. a receiver, in an environment with a markedly lower ambient temperature.

As a consequence of this temporal discrepancy in the time bases of the two network nodes A, B, it can happen that the transmission window of the network node A neither entirely covers the reception window of network node B nor partly overlaps with the reception window. In the following, a mispositioning of the reception window or a mispositioning of the transmission window will be understood by this set of facts. In this case the danger arises that no data and/or control commands

are received and that in this case there can also be no synchronization between the transmitter and the receiver.

For the elimination of this constellation of problems it is proposed in the German Laid-Open Specification DE 199 05 316 A1, for reliable avoidance of a synchronization loss, to equip a receiver of a data transmission system with a time control device for the estimation of the time point of each expected next data transmission. The time control device activates the receiving unit of the receiver immediately before the occurrence of a transmission of data packets.

In the case that the transmission of data packets does not take place precisely at the time point estimated by the time control device due to the time bases of the transmitter and the receiver running inconsistently, a correction of the position of the reception window, designated as “tolerance interval” in DE 199 05 316 A1, is carried out. This correction takes place through the multiplication of the time interval from the last data transmission of the transmitter to the expected next data transmission by a correction factor, which is determined from the relationship of the actual time interval to the theoretical time interval from the next-to-last to the last data reception.

In DE 199 05 316 A1 it is assumed that between the transmission of two data packets by a transmitter there is always a definite theoretical time interval. If the actual time interval differs from the theoretical time interval, then the reception window of the receiver for the next data transmission will be opened by the time control device earlier or later, corresponding to the correction factor as a quotient of the actual time interval to the theoretical interval from the next-to-last to the last data reception.

Prerequisite for this reception window correction is the fact that within the reception window of the receiver a data packet or synchronization message of a transmitter is actually received. With a complete mispositioning of the reception window, i. e. in the case of a synchronization message not lying within the temporal bounds of the reception window, the receiver consequently recognizes no reception, so that also no synchronization between the transmitter and the receiver can take place. Due to this serious disadvantage it is, for example, not possible to set up a network, in particular a sensor network, to integrate new nodes into a sensor network, or reintegrate lost network nodes of a network in it, since in these cases the transmitter and the receiver still have no knowledge of one another, and there is mispositioning of the receiving window of a receiver with respect to the transmitting window of a transmitter.

The invention is based on the objective of providing a method for the synchronization of at least two network nodes which are in a network designed for the wireless transmission of data and connect with one another, where in said network when two network nodes connect a minimal need for power is required, so that for a network node with an adequate small battery a long service lifetime of several years is attainable.

Furthermore, the invention is based on the objective of providing a network, in particular a sensor network for the wireless transmission of data, in particular usage measurement data, with at least two network nodes which connect with one another, in which a transmitting network node participates in the energy consumption required for the synchronization in the case of mispositioning of the reception window of a receiving network node so that the reception window does not absolutely have to be enlarged by the receiver.

This objective is realized by a method according to claim 1 as well as by a network with the features of claim 10. Advantageous developments of the invention are stated in the subordinate claims.

The participation of a transmitting network node in the energy consumption required for the synchronization in case of a mispositioning of the reception window of a receiving network node can be achieved according to the invention by the fact that the transmitting network node transmits synchronization messages in increased numbers in the form of pulses which permit the receiver, on reception of a synchronization message of this type, to align its reception window.

For this, a method for the synchronization of at least two network nodes (A, B) which are in a network designed for the wireless transmission of data, in particular sensor networks designed for the wireless transmission and processing of usage measurement data, and which connect with one another is proposed in which for the synchronization of network nodes, in order to initiate a communication connection between them, a synchronization message packet bounded within a time interval T_{SP} is transmitted by a first network node A with a plurality of spaced-apart synchronization messages at time intervals T₁.

An alignment of the time bases of the network nodes A, B before communication between them is thus possible, where the transmitting network node A participates in the energy expenditure required for the synchronization, which is needed by the receiver to find a synchronization message. It is advantageous in the process according to the invention that, for the synchronization, network node A itself only needs to use a small amount of energy.

Alternatively, or in combination with the transmission of synchronization message packets, the temporally bounded reception window can also be enlarged. This has the advantage that the probability of receiving a synchronization message within the reception window of network node B is increased in addition.

Moreover, a temporal alignment of the synchronization message packet of the transmitting network node A can also happen alternatively or in combination with the temporal alignment of the reception window of the receiver after successful reception. This requires an acknowledgement by the receiver of the receipt or reception of a synchronization message. Furthermore, it is to be noted that the synchronization message of a network node A can be “heard” by several network nodes B, C, where these network nodes know the transmission time point of the synchronization message and/or the synchronization message packet from A so that a temporal adaptation of network node A to network node B would have a greater time discrepancy between network node A and network node B as a consequence. A temporal alignment of the synchronization message packet of a transmitting sensor node A is thus only advantageous to a slight extent.

Furthermore, a continuous sequence of synchronization message packet to synchronization message packet can be carried out in order to additionally increase the probability of a hit, but in this case there is increased energy consumption by the transmitter.

In an additional alternative embodiment variant of the synchronization message packets according to the invention, a transmission of only few synchronization messages within a synchronization message packet can take place with sufficient temporal breadth of individual synchronization messages, whereby the energy consumption of the transmitting network nodes is not essentially altered.

For a further energy reduction it is advantageous to choose the number of synchronization messages within a synchronization message packet in a variable manner. Thus, for example, the number of synchronization messages within the synchronization message packet can be adapted depending on the ambient temperature of the network nodes to be synchronized and/or depending on the synchronicity between transmitting network node A and receiving network node B and/or depending on the calendar and/or depending on the usage. Synchronicity is understood to mean the temporal discrepancy between the clocks of two network nodes, where a small temporal discrepancy means a high synchronicity and a high temporal discrepancy means a low synchronicity.

For example, with high synchronicity between the clocks of two network nodes A, B the transmission of a few synchronization messages within a packet is sufficient. With low synchronicity on the contrary clearly more synchronization messages within a packet can be transmitted to increase the probability of a hit, where the duration of the corresponding synchronization message packet can be widened or also held constant. In the second case there is a reduction of the spacing of the individual synchronization messages within a synchronization message packet relative to one another and/or a reduction of the width of an individual synchronization message.

It is furthermore advantageous that at least one second network node B opens a temporally bounded reception window at temporal intervals T₂, within which a synchronization message can be received. With this a particularly energy-efficient connection between the network nodes A, B is made possible. Alternatively, network node B can also be switched permanently to reception but this state has unnecessarily high energy consumption.

It is particularly advantageous if the transmission of a synchronization message packet only occurs in the case of a synchronization message ST which does not lie, or does not lie completely, within the temporal bounds of the reception window and is independent of the synchronization message packet since in this case one can conclude that there is a temporal asynchronicity between the clocks of the networks A, B due to their synchronization message ST not being received so that a synchronization between them is not possible.

Alternatively or in addition, the transmission of synchronization message packets can also occur in the setup of a sensor network and/or in the integration of new nodes into an existing sensor network and/or in the reintegration of lost network nodes into the network. Thereby a quick and uncomplicated linking of the unlinked sensor nodes can be realized. In particular in embodiment examples of this type there can be an automatic transmission of synchronization message packets, where the possibility exists of realizing a network that sets itself up and/or repairs itself and/or integrates new network nodes by itself.

Alternatively or in addition, the transmission of synchronization message packets can also always be done through a network node A when it receives a reply to its synchronization message ST from a special network node B or from no other network node.

It is furthermore advantageous if at least to the synchronization messages transmitted within the time period T_{SP} an identifier is assigned which defines the position of these synchronization messages within the synchronization message packet. On reception of a synchronization message with an identifier, a receiver can recognize immediately whether or not the position of its reception window is optimal, or whether its time base is different from that of the transmitting network node so that it can independently make an adaptation of the temporal position of its window.

Alternatively, an identifier can also be assigned to all the synchronization messages, where, for example, an identification of a transmitter is also possible.

As an identifier of the synchronization messages transmitted within the time period T_{SP}, preferably a number around a reference synchronization message can be assigned to them. With this, a preferably electronic evaluation is possible in a particularly quick and simple manner. It is also advantageous here that, using the identifier, the receiver can recognize immediately whether its reception window is disposed too early or too late with regard to its position relative to the reference synchronization message.

Furthermore, the possibility presents itself of preferably providing all the synchronization messages within a synchronization message packet with identical spacing. With this, it is ensured that in the case of a temporal width of the reception window which is chosen preferably somewhat larger than the spacing between two synchronization messages within a synchronization message packet, a synchronization message is received. Alternatively, the spacing between two synchronization messages within a synchronization message packet can be non-constant. However, a larger reception window of the receiver is a prerequisite for this embodiment of the invention.

After successful reception of a synchronization message its identifier can be evaluated in such a manner, and a temporal adaptation, in particular a shift of the reception window, can be made in such a manner, that for the next following synchronization message ST independent of a synchronization message packet it lies in the range around this synchronization message or for the next following synchronization message packet it lies within the temporal bounds of this synchronization message packet. With this, synchronization between the transmitting and receiving network nodes is performed without a change of the internal clock of one of the two network nodes being necessary.

Alternatively or in addition, there can be a widening of the reception window after evaluation of the identifier but the temporal width of the reception window is limited by the battery capacity of a receiving network node and moreover produces no synchronization between the transmitter and the receiver within the network.

It is furthermore advantageous that there is transmission of a synchronization message (ST) of a first network node (A) to all the other nodes in the network but the opening of the reception window is only done by at least one second network node (B) which is disposed within the same hierarchy plane as the first network node (A) or in a directly adjacent, preferably lower, hierarchy plane. With this, the hierarchical structure within the network is taken into consideration, whereby the exchange of data and the administration of data and nodes within the network is simple, comprehensible, and not susceptible to errors. In particular, this feature promotes the scaleability of a network so that the integration of new nodes is possible in an easy manner.

Alternatively, it is also possible that each network node within the network can connect with every other network node of the network, for example, in the startup of a network but the communication is structured in this case in a more difficult manner, in particular the formation of communication paths.

It is advantageous if the temporal spacing between two synchronization messages within a synchronization message packet is chosen smaller than the temporal width of the reception window so that if the reception window lies completely within the synchronization message packet at least one synchronization message can be received. With this, the expenditure of energy required for synchronization is divided optimally between a network node A functioning as transmitter and a network node B functioning as receiver.

For the application, according to the invention, of the fundamental method within a network, a network is proposed, in particular a sensor network for the wireless transmission of data, in particular usage data, with at least two network nodes A, B which can connect with one another and which each comprise at least one transmitting unit and one receiving unit, a sensor unit, means for the temporal control of its transmitting and receiving operation, and a power supply, where the transmission unit of at least one first network node A transmits at least one synchronization message packet at time intervals T₁ and the receiving unit of at least one second network node B opens a temporally bounded reception window at time intervals T₂ within which the at least one synchronization message of the synchronization message packet can be received, where, after successful reception, communication can take place and where the connection of the two network nodes A, B is done according to the method according to one of the claims 1 to 9.

It is particularly advantageous here if the fundamental network is a hierarchical network, e. g. a tree structure, and the network nodes within the network are connected with one another bidirectionally. In this case the exchange of data and the administration of data and nodes within the network is simple, comprehensible, and not susceptible to errors. In particular, this feature promotes the scaleability of a network so that the integration of new nodes is possible in an easy manner.

In the following a preferred embodiment variant of the method according to the invention is described, or a network in which the method can find application. In a particularly advantageous version of the invention the network is formed as a sensor network.

For sensor networks in which the available energy reserves are the limiting factor for the data transmission rate, the manner in which two network nodes connect with one another is a particular challenge with regard to an energy-efficient procedure. The energy consumption within a sensor network can be reduced in particular by the fact that a network A functioning as transmitter and a network B functioning as receiver open their respective transmission and reception windows, which are both temporally bounded, at given time intervals. In the following, sensor node means a network node within a sensor network.

So that two sensor nodes within a sensor network can connect with one another, in particular bidirectionally, they comprise according to the invention at least one transmitting unit and one receiving unit, a sensor unit, means for the temporal control of its transmitting and receiving operation, and a power supply. Furthermore, they comprise a sensor unit with a sensor element for measuring physical quantities such as, for example, temperature, throughflow, and/or electrical power.

Economical, miniaturized time generators are preferably used for the temporal control of the transmission and reception operation, said time generators being realized by means of oscillating quartz crystals and thus having significant temperature dependence. In particular for sensor nodes A which are formed as a heat meter for recording heating costs, are preferably mounted on heating elements and/or lines, and transmit their measured data to a sensor node B functioning as a receiver which is energized by a low ambient temperature, time discrepancies between the time base of the sensor node A and that of the sensor node B arise which are in part significant and increase with time.

These time discrepancies can lead to a mispositioning of the reception window of the sensor node B so that a transmitted synchronization signal under certain circumstances is no longer detected. In order to ensure a reliable exchange of data and/or control commands between two sensor nodes, it is thus necessary to perform a synchronization between these nodes. For this, a sensor node A transmits at the time point t₁ a brief synchronization signal for the synchronization and for the initiation of a communication process.

Synchronization signals are frequently also denoted as synchronization messages and as a rule contain no data. They have the form and the temporal duration of a pulse, frequently in the range of one millisecond or less up to several hundred milliseconds. For this reason, synchronization messages are also known to those skilled in the art by the name “beacon.”

Other sensor nodes, e. g. a sensor node B, wake up at this time point t₁ or in a range around it and a synchronization, as well as subsequent communication, with the transmitting sensor node can take place. Through the synchronization process immediately before an occurring communication between two sensor nodes, a reliable exchange of data and/or control commands is ensured with a very low expenditure of energy.

Furthermore, with the method according to the invention a more time-efficient, and in particular a more energy-efficient, setup of a sensor network, an integration of new nodes into an existing sensor network in a simple manner, and a quick reintegration of lost nodes which requires little effort are possible.

Additional advantages and features of the invention follow from the following detailed description and the embodiment variants represented in FIGS. 1 to 5.

### BRIEF DESCRIPTION OF THE DRAWINGS

FIG. 1: Schematic sketch of a simplified network according to the invention with the sensor nodes A, B, C, and D,

FIG. 2a: Course of activity of the sensor nodes A, B, C, and D for synchronization without transmission of a synchronization message packet from A,

FIG. 2b: Course of activity of the sensor nodes A, B, C, and D for synchronization with transmission of a synchronization message packet from A,

FIG. 3: Course of activity of two sensor nodes A, B with mispositioning of the reception window of B,

FIG. 4: Illustration of the extension, according to the invention, of the synchronization interval to a virtual window,

FIG. 5: An embodiment variant for the assignment of an identifier for the synchronization messages,

FIG. 6: Example of a network, according to the invention, with more complex structure.

### DETAILED DESCRIPTION OF THE DRAWINGS

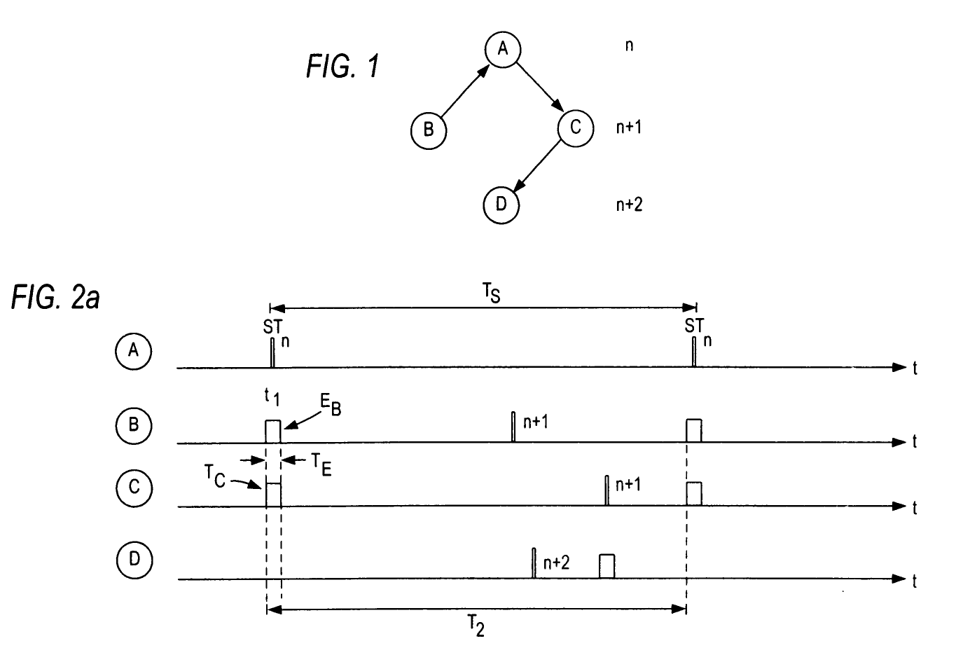

FIG. 1 shows a network structure of a network with the sensor nodes A, B, C, and D. This schematized representation of a simple network serves merely to illustrate the method according to the invention. The application of the method within a network and the associated network is not restricted to the number and arrangement, represented in FIG. 1, of nodes in the network.

In a preferred embodiment variant the network is a hierarchically structured network with a tree structure. In FIG. 1 a very simple network is illustrated which comprises, by way of example, 3 hierarchy planes whose indexing increases downwards. Sensor node A represents the root of the tree and is designated as the base. The corresponding hierarchy plane has the index 0 and is designated as the base plane.

The next lower hierarchy plane has the index 1 and is formed in this example by the sensor nodes B and C. Hierarchy plane 2 is formed here only by D. Between the sensor nodes directed edges in the form of arrows are represented which specify from which node to which node measurement data are transmitted.

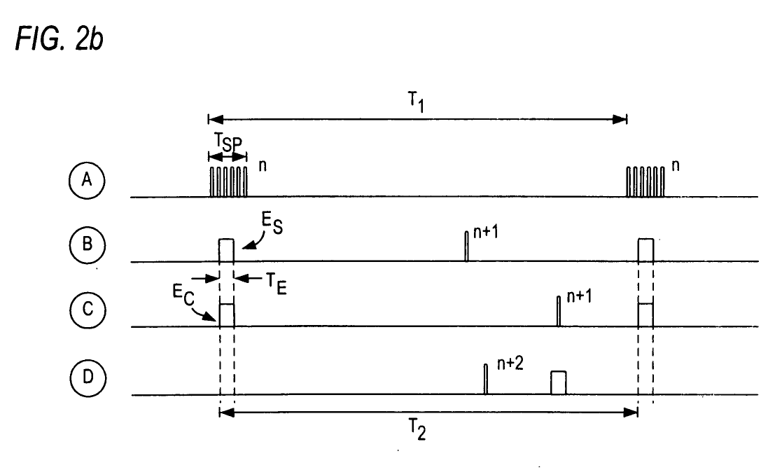

FIG. 2a illustrates the activities of the sensor nodes A, B, C, and D in connecting with one another according to proper procedure, i. e. when there is no mispositioning of the reception window, plotted over time t. To initiate communication, sensor node A transmits a synchronization message ST at the time point t₁ as well as an additional synchronization message at regular intervals T_{S}, e. g. every 5 to 10 minutes. With respect to this example the synchronization message ST has in a preferred embodiment variant a temporal width of several milliseconds, preferably 1 to 2 milliseconds.

As sensor nodes of the hierarchy plane lying directly below the hierarchy plane of sensor node A, sensor nodes B and C can know the time point of transmission of the synchronization message ST, are activated (“awakened”) by their time control device, and go into reception mode regularly at time intervals T₂, so that a synchronization to the transmitting sensor node as well as subsequent communication can be produced.

FIG. 2a furthermore shows that in an advantageous embodiment variant of the invention all the sensor nodes can transmit synchronization messages which however can be received only by certain sensor nodes which awake precisely at these time points of transmission. In the embodiment example of a network according to FIG. 1 sensor node A, also called the father, transmits a synchronization message and the sensor nodes B and C, children of A, listen. Moreover, sensor node C transmits a synchronization message and D listens. Sensor nodes B and D do indeed also transmit synchronization messages but in this example they both have no children so that no sensor nodes listen to them.

From the standpoint of energy it is favorable to choose the synchronization intervals T_{S} to be as long as possible. The fact that the clocks of the sensor nodes also do not run synchronously for short periods, e. g. due to the effect of temperature which is increased short-term, makes it necessary that the receiver(s), in the basic example formed by the sensor nodes B and C, must open its/their reception window(s) E_{B}, E_{C} somewhat before the expected time point of reception in order to receive the synchronization message reliably.

With an enlargement of the synchronization interval T_{S} a higher time discrepancy between the clocks of the sensor nodes A and B or A and C would develop so that the reception windows E_{B} and E_{C} would have to be enlarged as a consequence. The length of time t_{E} of the reception window is however limited in particular by the fact that the battery of a sensor node, e. g. a button cell, can make available only a limited amount of energy in the short term and frequently it happens that the time discrepancy between the clocks of two sensor nodes is greater than the maximum available length of the reception window. Synchronization is only possible within a reception window since for synchronization a synchronization message must be received. An enlargement of the reception window E_{B}, or E_{C} is thus often not possible or not advisable with regard to energy-efficient connection.

To increase the time period within which synchronization is possible, beyond the temporal bounds of the maximum possible reception window, it is proposed according to the invention to transmit from a first network node A at time intervals T₁ a synchronization message packet with a plurality of spaced-apart synchronization messages and bounded by a time period T_{SP}. This is represented in FIG. 2b by the illustration of the course of activities during connection of the network A, B or A, C for the synchronization according to the method according to the invention. A course of activities of this type is understood in the following to be the normal case. Synchronization message packets of this type can be described with the designation “beacon bursts.”

A sensor node A, functioning, for example, as transmitter, thus transmits not only one synchronization message but rather several synchronization messages with short spacing, where this time differential d is preferably somewhat below the maximum possible length of the reception window. With this it is ensured that when a reception window (E_{B}, E_{C}) is opened within the time period T_{SP} and at the same time the reception window lies entirely within the time period T_{SP} at least one synchronization message can be received and thus synchronization can occur.

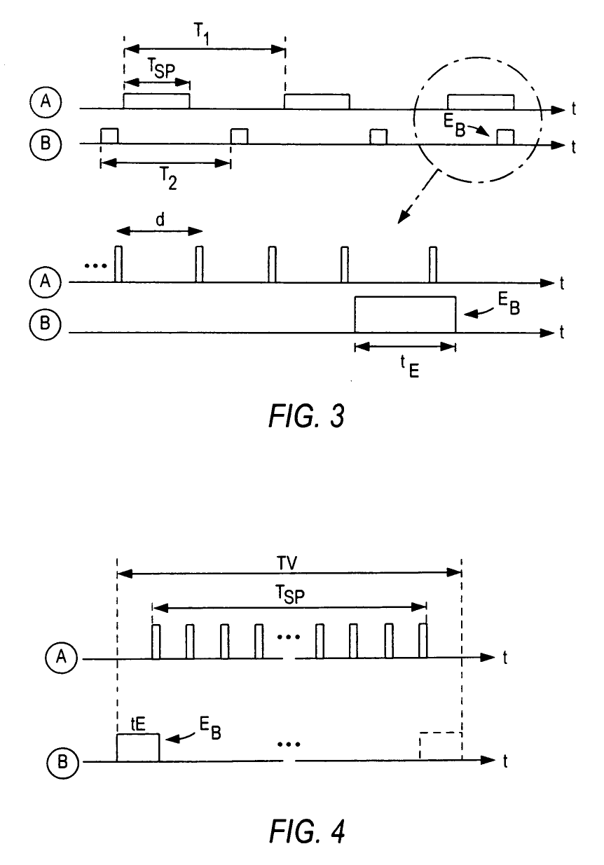

FIG. 3 shows the activity of two sensor nodes A, B according to the method based on the invention for the example of the startup of a sensor network and/or reintegration of an unlinked sensor node B, where the first sensor node A is represented as transmitter of a synchronization message packet and the second sensor node B represents a receiver. Due to an asynchronicity of the two clocks of the sensor nodes, where in FIG. 3, by way of example, the clock of sensor node B on average runs faster than the clock of sensor node A and the thereby resulting mispositioning of the reception window with respect to the signals transmitted from sensor node A, the sensor network must first be synchronized, or in case of reintegration of an unlinked sensor node B re-synchronized.

Since in normal operation with a high temporal asynchronicity of the clocks of the two sensor nodes A, B the probability is low that a receiver receives a synchronization message within its reception window, this probability for the occurrence of a connection and a subsequent communication must be increased. In the case of the known methods according to the state of the art the receivers switch to continuous reception for this purpose, which however is very power-intensive. According to the invention, sensor node A transmits synchronization message packets at intervals of time T₁ to increase the probability of a hit, said synchronization message packets being bounded in the time period T_{SP}.

A synchronization message packet can in this case contain many synchronization messages and be at most as long as the energy available at the moment permits. The transmission in this manner of many synchronization messages as a group could be designated “continuous fire.” Following the synchronization message there can be a recovery phase of the length T₁-T_{SP} after which the “continuous fire” can be resumed once again.

If a reception window falls at least partially in the range of a synchronization message packet so that a synchronization message can be received by sensor node B, synchronization and subsequent communication can take place. The enlargement of the section in which the reception window E_{B} lies in the range of the synchronization message packet shows that a synchronization message packet comprises a plurality of temporally spaced-apart synchronization messages, not all of which are represented in FIG. 3. In a particularly advantageous embodiment the synchronization messages have an identical spacing relative to one another.

In an alternative embodiment variant a synchronization message can directly follow the previous synchronization message so that the synchronization messages are not spaced apart within the synchronization message packet. This has the advantage that even in case of a very small reception window, e. g. due to a low battery capacity, there is nonetheless a high probability of receiving a synchronization message.

In a possible embodiment variant of the method according to the invention, in particular in the case of a startup of a network and/or in the case of self-repair of the network, the duration T_{SP} of a synchronization message packet with 10 to 20 synchronization messages can be several hundred milliseconds, e. g. 200 milliseconds. Furthermore, the interval T₁ between two sequential synchronization message packets can be several thousand milliseconds, e. g. 2000 milliseconds.

In the case of a particularly advantageous embodiment of the fundamental method, a synchronization message within a synchronization message packet has a temporal width of several milliseconds. A preferred spacing between two sequential synchronization messages within a synchronization message packet is approximately a few tens of milliseconds for a particularly energy-efficient method, preferably 15 milliseconds, but can also be chosen smaller or equal to zero.

FIG. 4 shows a synchronization message packet of a sensor node A, said synchronization message packet being bounded by a time period T_{SP}, as well as a sensor node B's reception window E_{B} projecting into the packet precisely so far that precisely the first synchronization message of the packet can be received by the node B. Furthermore, an alternative reception window of B is represented in dotted lines, where said alternative reception window projects out of the packet precisely so far that the last synchronization message of the packet can be received by node B.

If the reception window E_{B} is entirely within the packet, then at least one synchronization message can be received by node B since the temporal spacing of the individual synchronization messages relative to one another within the packet is preferably chosen somewhat smaller than the temporal width of the reception window E_{B}. The reception window E_{B} previously only available for synchronization is thus enlarged by its temporal width t_{E} in such a manner that a virtual reception window of the temporal width T_{V} arises within which synchronization between the sensor nodes A and B can take place.

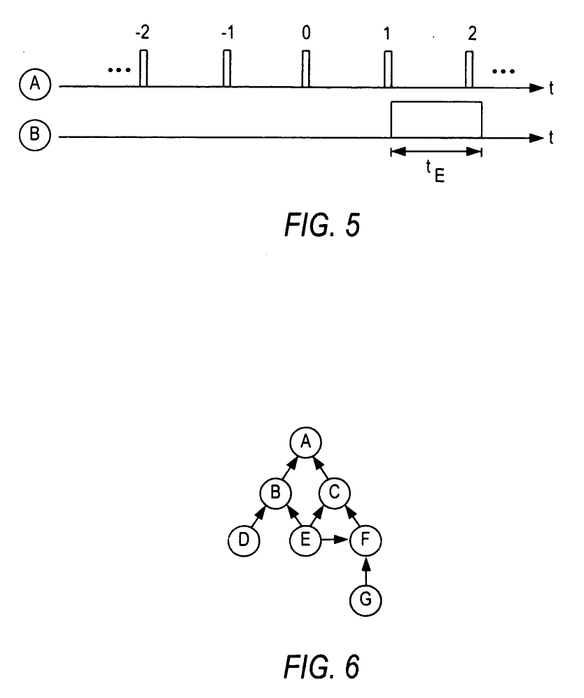

FIG. 5 shows a preferred embodiment variant of the method according to the invention in which an identifier is assigned to the individual synchronization messages within a synchronization message packet. This identifier can be transmitted with the synchronization message, e. g. in a header, where after successfully receiving one of the messages of the packet a receiver is directed to evaluate the identifier and based on this to adapt, preferably to shift, its reception widow temporally in such a manner that in the transmission of a next synchronization message independent of a synchronization message packet or of a next synchronization message packet of a sensor node A the reception window of the sensor node B is optimally placed around the synchronization message or in the center of this synchronization message packet, in particular lies within the temporal bounds of the synchronization message packet in order to ensure the reception of a synchronization message.

In a particularly advantageous embodiment the synchronization message packet has an odd number of synchronization messages, where one synchronization message is chosen as reference message, which, for example, can be formed by the central synchronization message within the synchronization message packet and preferably the number 0 is assigned to it as an identifier digit where the synchronization messages which are transmitted earlier in time than the reference message have a negative identifier digit and the synchronization messages which are transmitted later in time than the reference message have a positive identifier digit and permit deduction of their position in a simple manner.

Furthermore, it is advantageous to choose the number of synchronization messages within a synchronization message packet in a variable manner. Thus, for example, with a slight temporal discrepancy between the clocks of two sensor nodes A, B the transmission of a few synchronization messages is sufficient. For a higher temporal discrepancy on the contrary clearly more synchronization messages are transmitted to increase the probability of a hit, where the duration of the corresponding synchronization message packets and thus the duration of the virtual reception window is widened or can also be held constant. In the second case there would be a reduction of the spacing of the individual synchronization messages within the synchronization message packet relative to one another.

Based on the evaluation of the identifier of a synchronization message, the receiving sensor node B can determine the temporal position of its reception window within the synchronization message packet and thus also the temporal discrepancy of its clock with respect to the clock of the transmitting sensor node A. Within a communication following the synchronization and between sensor nodes A and B the information relating to a temporal discrepancy can be submitted to sensor node A which thereupon makes an adaptation of the number of synchronization messages within the synchronization message packet so that a time discrepancy-dependent adaptation or control of the number of synchronization messages within the synchronization message packet is possible.

Since the ambient temperature of a sensor node is determinative as the primary factor for the level of its temporal discrepancy (asynchronicity) with respect to another sensor node, there is an automatic adaptation of the number of synchronization messages within the synchronization message packet based on the temperature. In particular in the case of sensor nodes which can be fastened to heating elements as heat meters, high temporal discrepancies of the clocks with respect to the data collection points, which are preferably mounted far from a heating element, occur during heating.

Since, for example, a sensor node A functioning as a data collection station knows the ambient temperature of a sensor B functioning as a heat meter, sensor node A permits one to draw conclusions about the temporal discrepancy of its clock with respect to the clock of the sensor node B, with the aid of which an adaptation of the number of synchronization messages within the synchronization message packet can be made. If, for example, there is a high ambient temperature of a sensor B, then many synchronization messages are transmitted. If there is a low ambient temperature of a sensor B, then fewer synchronization messages are transmitted. In this way a temperature-dependent adaptation or control of the number of synchronization messages within the synchronization message packet can be realized.

Alternatively, a seasonally dependent and/or a calendar-dependent and/or a heating activity-dependent adaptation of the number of synchronization messages within the synchronization message packet can be realized. For example, it can be assumed in winter, i. e. with activated heating, that there can be a high temporal discrepancy between the clocks of a transmitting and a receiving sensor node on account of which the number of synchronization messages within the synchronization message packet must be increased in order to ensure a high probability of a hit.

Correspondingly, in summer, i. e. with deactivated heating, the number of synchronization messages within the synchronization message packet can be reduced since the probability of a mispositioning of the reception window with respect to a synchronization message packet occurring is low. Moreover, an average number of synchronization messages can be transmitted in the transitional months of spring and fall, whereby an additional significant reduction in the consumption of energy can be achieved.

The method of control of the number of synchronization messages within the synchronization message packet is advantageous in particular in connecting sensor nodes which form the heating expense distributor or heat meter since they comprise in particular clocks running asynchronously due to the high ambient temperature, and since in any case they measure the temperature of the respective heating element temperature-dependent control of the number of synchronization messages within the synchronization message packet presents itself here.

FIG. 6 shows a hierarchical network, according to the invention, with four hierarchy planes and 7 sensor nodes A to G as an example of a more complex network than in FIG. 1. Therein it is illustrated that in the method according to the invention it does not have to be the case exclusively that a sensor node of a lower hierarchy plane is a child of only one node of the hierarchy plane lying directly above it. In this example sensor node E forms a child of sensor nodes B and C and thus “hears” all the synchronization messages of B and C.

This has the advantage that in the case of a fault between the sensor nodes E and C, as a consequence of which a communication connection between them cannot be established, a connection via sensor node B is possible as an alternative communication path to sensor node A. An also alternative communication connection, here however from E to C, is formed in the example according to FIG. 6 between E and F. If the communication connection between E and C fails, then data transmission to C from E via F can take place. This particularly advantageous embodiment variant offers a high fault tolerance of individual communications connections due to the introduction of redundant communication paths and thus ensures a high reliability of transmission.

The exemplary network according to FIG. 6 can thus be described as follows. Sensor node A represents the base station and has no parent component. Sensor node A thus transmits in the connection phase only synchronization messages but opens no reception window for the synchronization messages of other sensor nodes. Sensor node E sees three additional nodes in its immediate vicinity and thus opens a reception window for synchronization messages which are transmitted by B, C, and F. Node E has furthermore 2 parent components, namely B and C and, due to the possibility of communication with node F, node E has two redundant communication connection possibilities. Finally, the nodes D, E and G have no children so that no reception window is opened for their synchronization messages.

Preferably the direct communication with the network according to the invention is done only between two sensor nodes which are disposed either within the same hierarchy plane or are located in two different immediately adjacent hierarchy planes. With this a uniform data transfer within the network is ensured and the hierarchical structure is taken into consideration.

The transmission of a synchronization message ST of a first sensor node A is thus preferable to all the other nodes in the network, but the opening of a reception window is only done by at least one second sensor node B which is disposed within the same hierarchy plane as the first sensor node A or in a directly adjacent, preferably lower, hierarchy plane.

The method of transmission of synchronization message packets can in particular also be used to setup a network, for example, in the startup, or also in the independent repair, of the network in the case of a temporary failure of connection with a sensor node. Also, the integration of new sensor nodes with the aid of the method which is the basis of the invention is simple and easily possible. For this it is proposed that, for example, all the linked sensor nodes regularly transmit synchronization message packets which are provided with information which specifies to which network they belong. An unlinked sensor node must search for and find these synchronization message packets or synchronization messages within a packet in order to be able to integrate itself (once again) into the network.

Since due to the constellation of problems described only relatively brief reception windows can be realized, the probability of a hit in merely transmitting synchronization messages instead of packets is extraordinarily small. Thus, the possibility presents itself of having linked sensor nodes constantly transmit synchronization message packets in order in this way to clearly increase the probability of a hit with which a reception window falls precisely on a synchronization message and thus to make possible the integration of unlinked nodes in a simple manner for the purpose of setting up a network or for the startup of a network or the repair (remedy) of a network.

For the initiation of communication following a successful reception of a synchronization message in a preferred embodiment variant of the method according to the invention, a sensor node A, after transmitting a synchronization message, switches into a hearing mode which is characterized by the activation of the reception unit of the sensor A. If a synchronization message was successfully received by a sensor node B, then it transmits a signal back to node A with which it communicates its presence in the network to node A. Subsequently, there can be communication, in particular a transmission of usage data from node B to node A.

1-11. (canceled)

12. A method for the synchronization of at least two wireless network nodes (A, B) comprising:
initiating a communication connection between the network nodes,
transmitting a synchronization message packet bounded within a time period (T_{SP}) from a first network node (A) at time intervals (T_{V}) with a plurality of synchronization messages, and
opening a second network node (B) temporally bounded reception window at time intervals (T₂) within which the at least one synchronization message can be received.

13. The method of claim 12 wherein the wireless network nodes (A, B) communicate in a sensor network designed for the processing of usage measurement data.

14. The method according to claim 12 wherein the transmission of a synchronization message packet occurs as a synchronization message (ST) which does not lie completely within the temporal bounds of the reception window and is independent of the synchronization message packet.

15. The method according to claim 12 wherein the transmission of a synchronization message packet occurs in the setup of a sensor network.

16. The method according to claim 12 wherein the transmission of a synchronization message packet occurs in the integration of new nodes into an existing sensor network.

17. The method according to claim 12 wherein the transmission of a synchronization message packet occurs in reintegration of lost network nodes into the network.

18. The method according to claim 12 wherein an identifier is assigned which defines the position of these synchronization messages within the synchronization messages packet for the synchronization messages transmitted within the time period (T_{SP}).

19. The method according to claim 18 wherein a number around a reference synchronization message is assigned as an identifier of the synchronization messages transmitted within the time period (T_{SP}).

20. The method according to claim 12 wherein at least one synchronization message within the synchronization message packet is spaced apart from another synchronization message within the synchronization message packet.

21. The method according to claim 20 wherein all the synchronization messages within the synchronization message packet have identical spacing.

22. Method according to claim 18 wherein after successful reception of a synchronization message its identifier is evaluated in such a manner, and a temporal adaptation, in particular a shift of the reception window, is made in such a manner, that for the next following synchronization message ST independent of a synchronization message packet lies in the range around this synchronization message or for the next following synchronization message packet lies within the temporal bounds of this synchronization message packet, in particular in the center of this synchronization message packet.

23. The method according to claim 12 wherein there is transmission of a synchronization message (ST) of a first network node (A) to all the other nodes in the network but the opening of the reception window only occurs from at least one second network node (B) which is disposed within the same hierarchy plane as the first network node (A) or in a directly adjacent, preferably lower, hierarchy plane.

24. The method according to claim 20 wherein the temporal spacing between two synchronization messages within a synchronization message packet is chosen to be smaller than the temporal width of the reception window so that if the reception window lies completely within the synchronization message packet at least one synchronization message can be received.

25. The method according to claim 12 wherein the number of synchronization messages within the synchronization message packet is adapted depending on the ambient temperature of the network nodes to be synchronized or depending on the synchronicity between transmitting network node (A) and receiving network node (B) and/or depending on the calendar and/or depending on the usage.

26. A network with at least two network nodes (A, B) which can be connected with one another and which each comprise at least one transmitting unit and one receiving unit comprising:
a sensor unit,
means for the temporal control of the sensor units transmitting and receiving operation,
a power supply wherein the transmission unit of at least one first network node (A) transmits at least one synchronization message packet at time intervals (T₁); and wherein the receiving unit of at least one second network node (B) opens a temporally bounded reception window at time intervals (T₂) within which a synchronization message of the synchronization message packet can be received, where, after successful reception, communication can take place.
